(19) United States
(12) Patent Application Publication
(10) Pub. No.: US 2005/0284525 A1
(43) Pub. Date: Dec. 29, 2005

(54) Manually-operated piloted control-reliable lockout valve

(76) Inventors: Richard E. Schnell, Oswego, IL (US); Eric O. Cummings, Lexington, SC (US)

Correspondence Address: ROSS CONTROLS, 1250 KIRTS BLVD., PO BOX 7015, TROY, MI, 48007-7015, US

(21) Appl. No.: 10/877,411

(22) Filed: Jun. 25, 2004

(51) Int. Cl. F15B 20/00

(52) U.S. Cl. 137/596.16

(57) ABSTRACT

A control-reliable lockout valve system has an inlet port for coupling to a source of pressurized fluid and an outlet port for coupling to a downstream fluid-actuated device. A double valve unit includes a pair of valve elements each controllably moving between a respective actuated position and a deactuated position to control a first flow path between the inlet port and the outlet port in response to a pilot pressure applied to the valve elements. The first flow path provides the pressurized fluid to the outlet port only if both of the valve elements are in the respective actuated positions. The double valve unit further includes an exhaust port, and the valve elements control a second flow path for coupling the outlet port to the exhaust port unless both of the valve elements are in the respective actuated positions. A pilot supply valve is provided having an inlet for coupling to the source of pressurized fluid, an outlet coupled to the double valve unit, and a manually actuated valve element for selectably applying the pilot pressure to the valve elements of the double valve unit, whereby the manually actuated valve element can be closed to isolate the valve elements of the double valve unit from the pilot pressure to lockout the valve system in a control-reliable manner.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to fluid-control lockout valves, and, more specifically, to piloted, manually-actuated lockout valves that provide energy isolation in high capacity systems in a control-reliable manner.

Compressed fluid systems are used in many industrial settings to operate various types of pressure-controlled actuators. Pneumatic systems use air or other gasses as the working fluid. Hydraulic systems use oil or other liquids. In a typical system, air or other working fluid is compressed by a compressor and delivered to the actuators via a distribution system including conduits and valves. Some systems may cover a very large area with one or more high capacity compressors pumping compressed air or other fluid into an extensive network of delivery conduits. The network typically includes sections that can be isolated from the compressor(s) by closing certain valves known as lockout valves. This allows portions of the system to be disassembled for maintenance or other reasons.

Prior to attempting to disassemble or service a pneumatic or hydraulic system, it is necessary to ensure that the supply of pressurized fluid is removed from the point in the system being accessed and that residual pressure is released. Various safety standards and governmental requirements exist which establish that lockout of a particular portion of a system be achieved in a control-reliable manner or by a directly-operated manual valve.

Control reliability means that an extremely high confidence factor is present (e.g., near 100%) such that when an attempt is made to actuate a valve function, the function happens. According to a standard definition, control reliable devices are redundant, monitored for their performance, and they fail to a safe condition which inhibits further operation until the failure is corrected. A manual control is often required, and a mechanical locking device (such as a padlock) installed to ensure that the pressurized fluid remains shut off during machine repair or other operation.

High capacity fluid distribution systems require valves with larger port sizes and larger valve elements (i.e., poppets or spools). At larger valve sizes or higher operating pressures, the actuating force required to move the valve element between its open and closed positions could become too high for convenient manual actuation by some persons. Larger valves (such as the 27 Series poppet valves sold by Ross Controls) use pilot actuation to offset the higher forces by employing a smaller valve to control the application of pressurized fluid to actuate the larger valve. However, the pilot-actuated control valves of the prior art have not been control-reliable since they are not redundant nor monitored, and therefore, actuation of a pilot element does not sufficiently ensure corresponding actuation of the main flow-control valve. If the main valve were to stick in its open position, then high-pressure fluid could continue to flow through the valve even though the pilot valve made it appear that the flow was shut off.

### SUMMARY OF THE INVENTION

The present invention has the advantage of achieving control-reliability for locking-out flow control valves that would otherwise require excessive actuation forces when using a manual shutoff. Valve redundancy, monitoring, and a “fail to safe” design yield a control-reliable confidence level for the lockout operation.

In one aspect of the invention, a control-reliable lockout valve system having an inlet port for coupling to a source of pressurized fluid and an outlet port for coupling to a downstream fluid-actuated device is provided. A double valve unit includes a pair of valve elements each controllably moving between a respective actuated position and a deactuated position to control a first flow path between the inlet port and the outlet port in response to a pilot pressure applied to the valve elements. The first flow path provides the pressurized fluid to the outlet port only if both of the valve elements are in the respective actuated positions. The double valve unit further includes an exhaust port, and the valve elements control a second flow path for coupling the outlet port to the exhaust port unless both of the valve elements are in the respective actuated positions. A pilot supply valve is provided having an inlet for coupling to the source of pressurized fluid, an outlet coupled to the double valve unit, and a manually actuated valve element for selectably applying the pilot pressure to the valve elements of the double valve unit, whereby the manually actuated valve element can be closed to isolate the valve elements of the double valve unit from the pilot pressure to lockout the valve system in a control-reliable manner. In one optional embodiment, one or more solenoid-operated valves can be connected in the pilot circuit to provide remote or automatic control of application of pilot pressure to the double valve unit.

### BRIEF DESCRIPTION OF THE DRAWINGS

FIG. 1 is a schematic, block diagram of a system utilizing pressurized fluid to operate machinery, such as a pneumatic or hydraulic system.

FIG. 2 is a cross-sectional view of a manually-operated lockout valve of the prior art in a closed or locked-out position.

FIG. 3 is a cross-sectional view of a manually-operated lockout valve of the prior art in an open position.

FIG. 4 is a schematic diagram of one preferred embodiment of the piloted lockout valve system of the present invention which provides electrical signal feedback to an external monitoring system (not shown). Other types of self-contained monitoring systems may also be used, as known in the art.

FIG. 5 is a cross-sectional view of one preferred embodiment of the valve system of FIG. 4.

FIG. 6 is a schematic diagram of another preferred embodiment of the piloted lockout valve system of the present invention including remote controlled electrical shutoff.

FIG. 7 is a cross-sectional view of on embodiment of the valve system of FIG. 6.

### DETAILED DESCRIPTION OF PREFERRED EMBODIMENTS

The present invention incorporates a manually actuated pilot device with a double valve to achieve a high level of reliability. The pilot device reduces the amount of force necessary to operate the lockout valve, so that no special strength or tools are necessary to activate the lockout function. By using a double valve, control-reliability is obtained since the double valve is redundant, monitored, and if one valve fails to properly actuate or deactuate, the second valve provides the desired function. The malfunction of the one valve element is detected by performing monitoring and the user is automatically warned that a fault has occurred. As a consequence of the fault, the back-up function is no longer available so that the valve needs to be repaired before placing the system back into service.

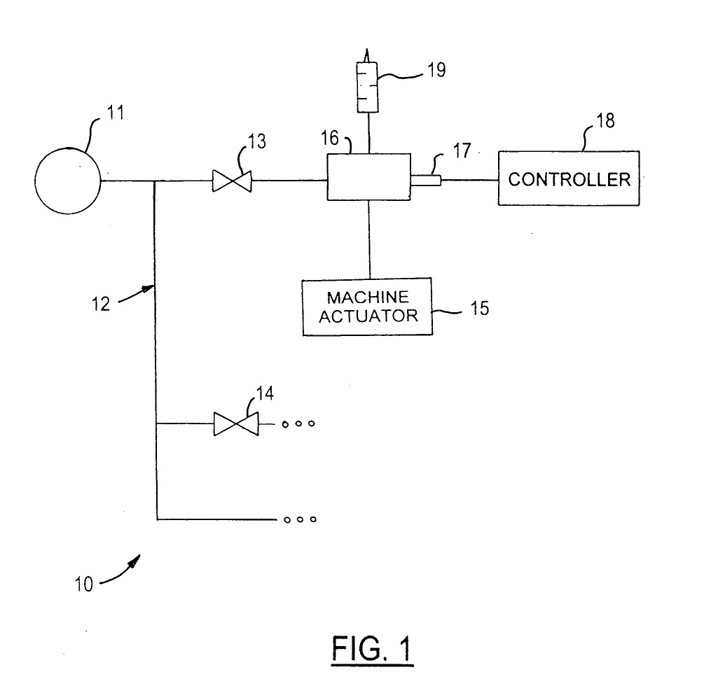

Referring to FIG. 1, a pressurized fluid (e.g. compressed air) system 10 includes a compressor 11 coupled to a fluid distribution system 12. Distribution system 12 may include a plurality of compressed air conduits interconnected by lockout valves 13 and 14 to various sub-circuits. Each sub-circuit may include various pneumatic actuators such as a machine actuator 15 for receiving compressed air within a particular sub-circuit via a control valve 16. Valve 16 may include a solenoid pilot 17 which is energized from a controller 18. A control signal from controller 18 causes valve 16 to couple the fluid conduit to machine actuator 15 either to the source of pressurized fluid or to an exhaust port including a silencer 19.

In order to safely perform maintenance upon machine actuator 15 or valve 16, lockout valve 13 must be closed in order to remove the source of pressurized fluid from the corresponding sub-circuit. Compressor 11 may continue to provide pressurized fluid to other sub-circuits.

A manually operated lockout valve of the prior art is shown in FIG. 2. A valve body 20 includes an inlet port 21, an outlet port 22, and an exhaust port 23. A valve spool 24 is movable longitudinally within the valve body to selectably connect inlet port 21 to outlet port 22 using manual force applied to a handle 25. FIG. 2 shows the lockout valve in a closed position wherein a locking hole 26 in valve body 20 is aligned with a slot 27 in handle 25 for receiving a padlock or other lock to fix the lockout valve in the closed position when desired.

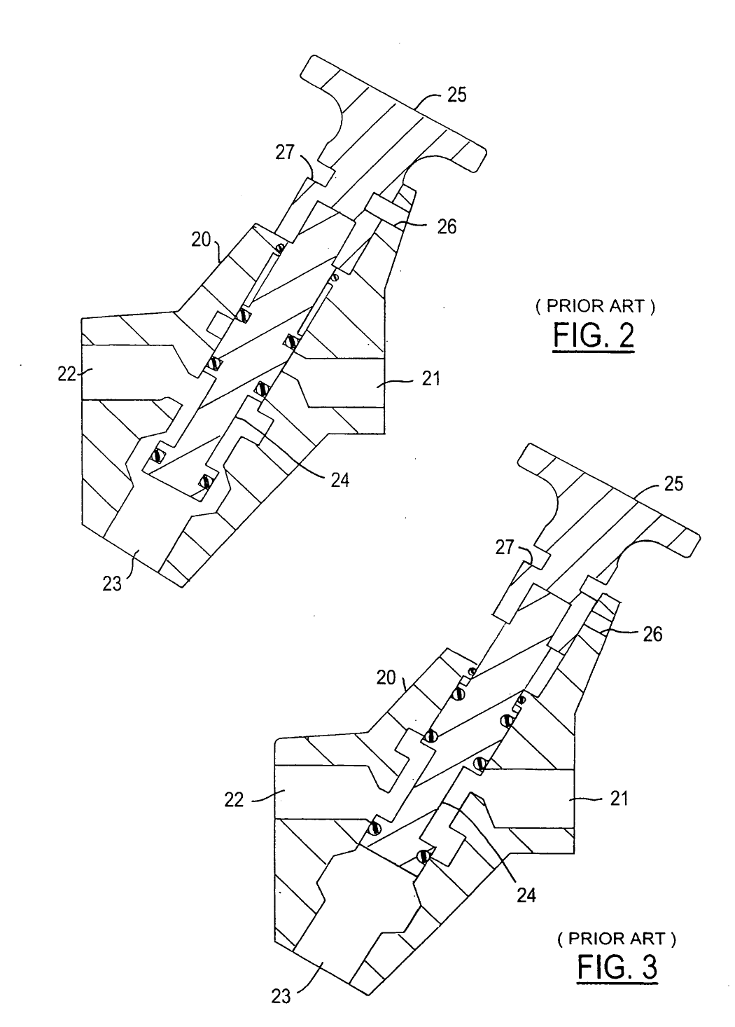

FIG. 3 shows the lockout valve in an open position allowing fluid flow through the valve. Locking hole 26 is no longer aligned with slot 27 and therefore the lockout valve cannot be locked in the open position.

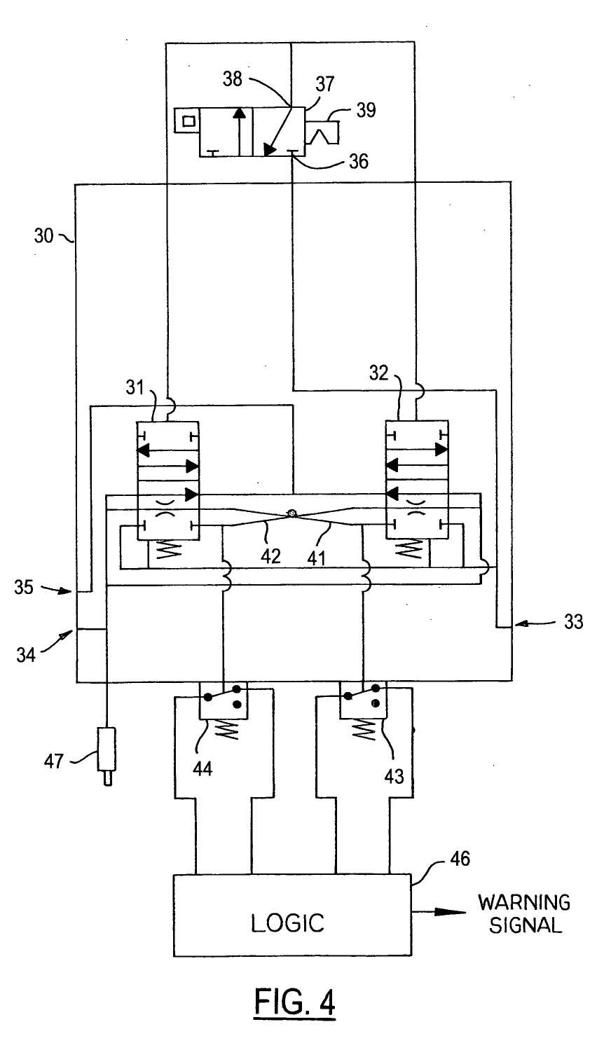

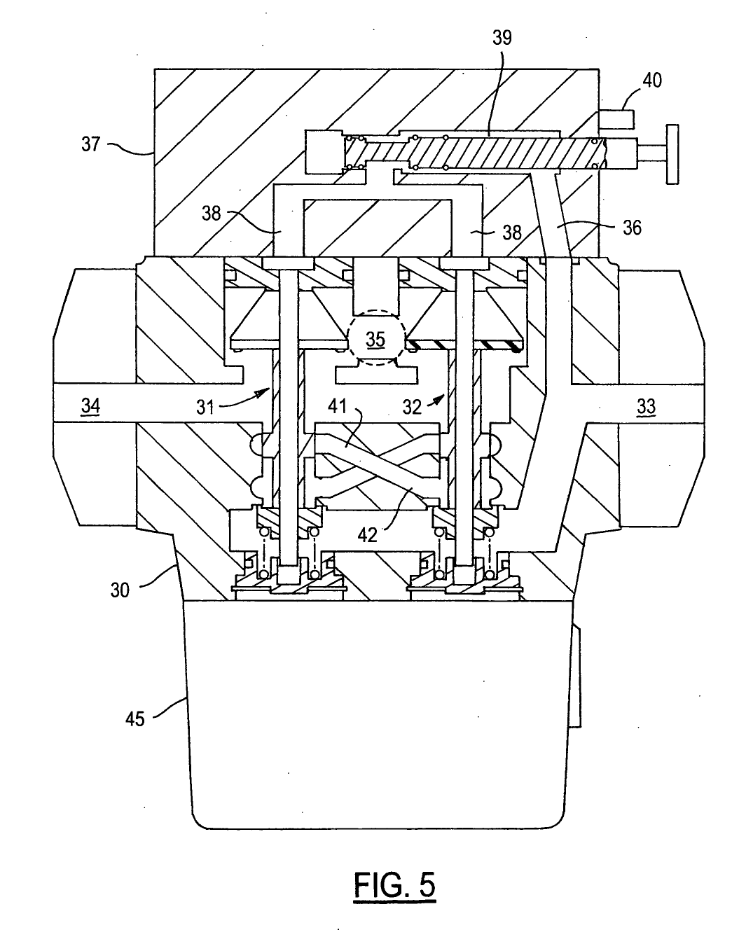

FIG. 4 shows one schematic representation of the pilot-controlled double valve of the present invention. A valve body 30 implements a double valve unit including a first valve element 31 and a second valve element 32. Valve body 30 further includes an inlet port 33, an outlet port 34, and an exhaust port 35. Valve elements 31 and 32 may be contained in a double valve unit of a known type such as the SERPAR® cross-flow double valve of Ross Controls as shown in FIG. 5. Inlet port 33 is coupled to valve elements 31 and 32 and to an inlet 36 of a manually-operated pilot valve 37. An outlet 38 of pilot supply valve 37 is coupled to valve elements 31 and 32 in order to actuate the double valve unit. Pilot supply valve 37 has a manually actuated valve element 39 for selectably coupling pressurized fluid to double valve elements 31 and 32. A locking feature 40 is provided in order to lock valve element 39 in a deactuated position wherein pressurized fluid is blocked from outlet 38. Locking feature 40 may include a locking hole that becomes aligned with a locking groove in the spool portion of valve element 39 when in the deactuated position, for example.

The double valve unit includes crossover passages 41 and 42 which cross-couple the valve elements to provide monitoring and inhibit further operation of the double valve unit whenever either valve element fails to operate as intended. Pressure switches 43 and 44 contained in a monitor assembly 45 are coupled to crossover passages 41 and 42, respectively. Pressure switches 43 and 44 detect the actuated or deactuated positions of the valve elements, and the resulting electrical signals from pressure switches 43 and 44 are coupled to a logic block 46 to generate a warning signal when the pressure switches indicate non-matching pressures exist in the first and second crossover passages. The identity of a failed valve element can also be determined based on which crossover passage is at nominal pressure while the other crossover passage is unpressurized due to a failure. Any type of monitoring device other than the pressure switches as shown can also be used, such as monitors available from Ross Controls under the names of Cross Mirror, Ross E-P monitor, Ross L-G monitor, and Ross DS monitor.

When manual pilot supply valve 37 is deactuated in order to obtain a lock-out position and isolate a pneumatic sub-circuit, it is highly likely that at least one valve element of the double valve unit will deactuate, thereby achieving the required isolation. However, if one valve element fails to deactuate then the double valve unit will remain in a faulted condition and the valve system cannot be reopened regardless of the position of the manual pilot supply valve. By providing monitoring with the pressure switches, the faulted condition can be indicated to an operator and repairs can be made to correct the problem with the faulted valve element.

A visual pressure indicator 47 may optionally be coupled to outlet port 34 to provide a method for verifying the complete release of pressure/energy in the system. A visual indicator such as the 988H30 visual indicator from Ross Controls can be used. The pressure indicator unit has a predetermined threshold to show whether pressure is present at the outlet port at greater or less than the threshold pressure. The threshold is selected based upon safety requirements of the particular system, for example.

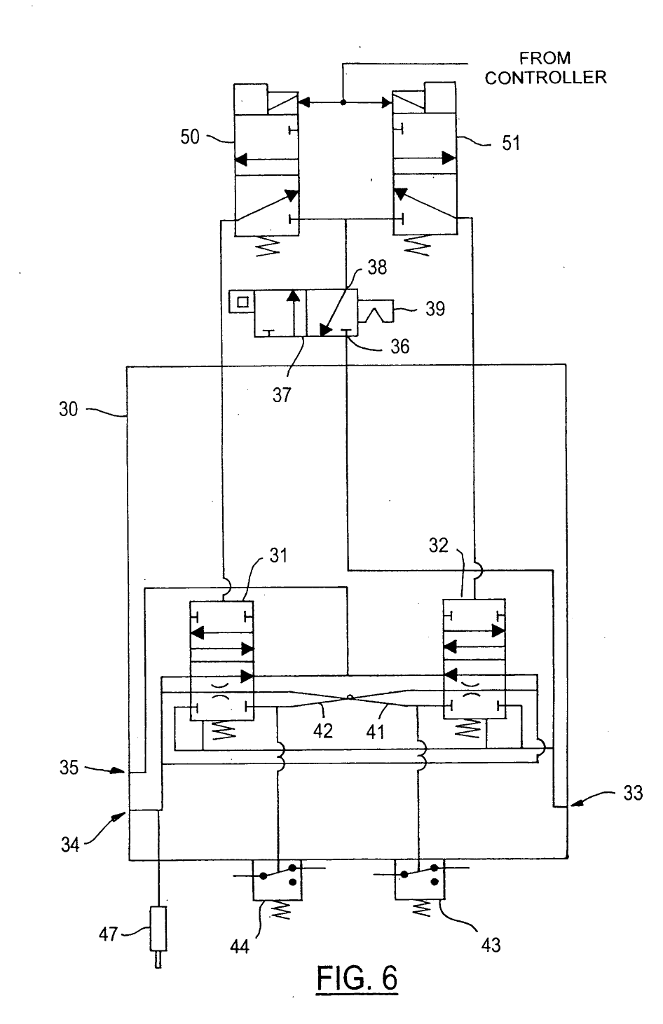

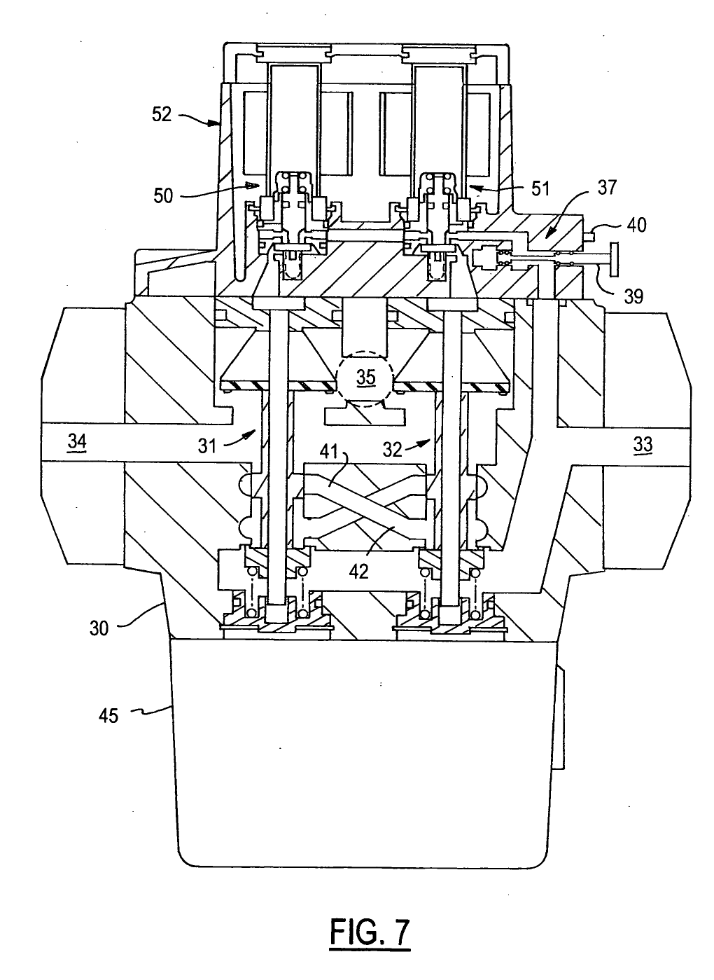

FIGS. 6 and 7 illustrate an alternative embodiment with an additional ability to activate the lockout function using a remote control signal from a remote controller applied to a pair of solenoid-operated valves 50 and 51 coupled in series with the pilot supply pressure from outlet 38 of pilot supply valve 37. The outlets of solenoid-operated valves 50 and 51 are coupled to valve elements 31 and 32, respectively, so that pilot pressure to the double valve unit can be selectably interrupted from a remote control station, if desired. Solenoid-operated valves 50 and 51 may be integrated with the manual pilot supply valve 37 in a pilot assembly 52 coupled to valve body 30 as shown in FIG. 7.

1. A control-reliable lockout valve system having an inlet port for coupling to a source of pressurized fluid and an outlet port for coupling to a downstream fluid-actuated device, said system comprising:
a double valve unit including a pair of valve elements each controllably moving between a respective actuated position and a deactuated position to control a first flow path between said inlet port and said outlet port in response to a pilot pressure applied to said valve elements, wherein said first flow path provides said pressurized fluid to said outlet port only if both of said valve elements are in said respective actuated positions, wherein said double valve unit further includes an exhaust port, and wherein said valve elements control a second flow path for coupling said outlet port to said exhaust port unless both of said valve elements are in said respective actuated positions; and
a pilot supply valve having an inlet for coupling to said source of pressurized fluid, an outlet coupled to said double valve unit, and a manually actuated valve element for selectably applying said pilot pressure to said valve elements of said double valve unit, whereby said manually actuated valve element can be closed to isolate said valve elements of said double valve unit from said pilot pressure to lockout said valve system in a control-reliable manner.

2. The control-reliable lockout valve system of claim 1 further comprising:
valve position sensors for detecting actuated or deactuated positions of said valve elements of said double valve unit, respectively.

3. The control-reliable lockout valve system of claim 1 further comprising:
first and second crossover passages in said double valve unit for coupling said valve elements of said double valve unit; and
first and second pressure switches coupled to said first and second crossover passages, respectively.

4. The control-reliable lockout valve system of claim 3 further comprising;
a logic block coupled to said first and second pressure switches for determining which one of said valve elements is in a failure condition in response to said first and second pressure switches indicating non-matching pressures in said first and second crossover passages.

5. The control-reliable lockout valve system of claim 1 further comprising:
a pressure indicator unit coupled to said outlet port for providing a visual pressure indication according to whether a pressure at said outlet port is greater to or less than a predetermined pressure.

6. The control-reliable lockout valve system of claim 1 further comprising a solenoid-operated valve connected in series with said pilot supply valve for selectably blocking said pilot pressure in response to a remote control signal.

7. The control-reliable lockout valve system of claim 1 further comprising:
a first solenoid-operated valve connected in series with said pilot supply valve for selectably blocking said pilot pressure to a first one of said valve elements of said double valve unit in response to a remote control signal; and
a second solenoid-operated valve connected in series with said pilot supply valve for selectably blocking said pilot pressure to a second one of said valve elements of said double valve unit in response to said remote control signal.

8. A method for controlling the locking-out of a valve system in a control-reliable manner, said valve system connected for selectably coupling a source of pressurized fluid to a downstream fluid-actuated device, said method comprising the steps of:
coupling said source of pressurized fluid to an inlet port of a double valve unit;
coupling said downstream fluid-actuated device to an outlet port of said double valve unit, said double valve unit including a pair of valve elements each controllably moving between a respective actuated position and a deactuated position to control a first flow path between said inlet port and said outlet port in response to a pilot pressure applied to said valve elements, wherein said first flow path provides said pressurized fluid to said outlet port only if both of said valve elements are in said respective actuated positions, wherein said double valve unit further includes an exhaust port, and wherein said valve elements control a second flow path for coupling said outlet port to said exhaust port unless both of said valve elements are in said respective actuated positions;
coupling a pilot supply valve between said source of pressurized fluid and said valve elements of said double valve unit to apply said pilot pressure to said valve elements in order to place said valve system in an open condition; and
manually deactuating said pilot supply valve element in order to place said valve system in a closed condition to isolate said valve elements of said double valve unit from said pilot pressure to lockout said valve system.

9. The method of claim 8 further comprising the steps of:
detecting actuated or deactuated positions of said valve elements of said double valve unit, respectively; and
indicating a malfunction of said valve system in response to said actuated or deactuated positions and a desired condition of said valve system.

10. The method of claim 8 wherein said double valve unit includes first and second crossover passages for coupling said valve elements of said double valve unit, and wherein said method further comprises the step of monitoring pressure in said first and second crossover passages.

11. The method of claim 10 further comprising the step of:
detecting a failure condition of one of said valve elements in response to non-matching pressures in said first and second crossover passages.

12. The method of claim 8 further comprising the step of:
providing a visual pressure indication according to whether a pressure at said outlet port is greater to or less than a predetermined pressure.

13. The method of claim 8 further comprising the steps of:
connecting a solenoid-operated valve in series with said pilot supply valve; and
selectably blocking said pilot pressure by closing said solenoid-operated valve in response to a remote control signal.

14. The method of claim 8 further comprising the steps of:
connecting a first solenoid-operated valve in series with said pilot supply valve and a first one of said valve elements of said double valve unit;
connecting a second solenoid-operated valve connected in series with said pilot supply valve and a second one of said valve elements of said double valve unit; and
selectably blocking said pilot pressure by closing said first and second solenoid-operated valves in response to said remote control signal.
